(19) United States
(12) Patent Application Publication
(10) Pub. No.: US 2016/0371859 A1
(43) Pub. Date: Dec. 22, 2016

(54) IMAGE DISPLAY SYSTEM AND IMAGE DISPLAY METHOD

(71) Applicant: Seiko Epson Corporation, Tokyo (JP)

(72) Inventor: Toshiki Fujimori, Chino-shi (JP)

(21) Appl. No.: 15/188,318

(22) Filed: Jun. 21, 2016

(30) Foreign Application Priority Data
Jun. 22, 2015 (JP) 2015-124490

(51) Int. Cl. G06T 11/00; H04N 9/31; G06T 11/20

(52) U.S. Cl. CPC G06T 11/001; G06T 11/203; H04N 9/31

(57) ABSTRACT

A second projector includes a second projection section that projects an image onto a second area; a second storage section that stores an attribute; a second control section that causes the second projection section to project an image of the line which is a line according to the locus of the indicator and which is drawn using the attribute stored in the second storage section, and an acquisition section that acquires the attribute stored in the first storage section. In a case in which a locus that is temporally or spatially continued and is extended from the first area to the second area is drawn by the indicator, the second control section causes the second projection section to project the image of the line which is a line according to the locus of the indicator and which is drawn using the attribute acquired by the acquisition section.

The entire disclosure of Japanese Patent Application No. 2015-124490, filed Jun. 22, 2015 is expressly incorporated by reference herein.

### BACKGROUND

1. Technical Field

The present invention relates to a technology which designates an attribute of a line to be drawn in a display system which draws the line according to a locus of an indicator.

2. Related Art

In a so-called interactive projector or a touch device, generally, a plurality of lines, which are drawn in a fixed time, or a line, which is drawn by a single stroke, is managed as a single object. It is possible to change an attribute, such as a color of an object which is already drawn, afterwards. However, in a case in which the attribute of the object is changed afterwards, procedures of first selecting a target object and subsequently designating an attribute desired to be changed are necessary. For example, Japanese Patent No. 4424592 discloses a change in content of a tool bar according to the operation history of a user in order to improve the efficiency of an operation of changing the attribute of the object.

A display system in which a plurality of projectors are arranged to display a large image has been known. However, in the technology disclosed in Japanese Patent No. 4424592, use of the plurality of projectors is not assumed.

### SUMMARY

An advantage of some aspect of the invention is to provide a technology which, in a case in which a locus that is temporally or spatially continued and is extended from a first area to a second area is drawn by one indicator in a display system which includes a first projector and a second projector, is capable of easily determining an attribute of a line, which is drawn in the second area according to the locus, according to an attribute of a line which is drawn in the first area.

An image display system according to a first aspect of the invention includes: a first projector; and a second projector, in which the first projector includes a first projection section that projects an image onto a first area; a first storage section that stores a first attribute which is an attribute of the line in a case in which a line is drawn according to a locus of an indicator,; and a first control section that causes the first projection section to project an image of the line which is a line according to the locus of the indicator in the first area and which is drawn using the first attribute, in which the second projector includes a second projection section that projects an image onto a second area which has at least a part different from the first area; a second storage section that stores a second attribute which is an attribute of the line in a case in which a line is drawn according to the locus of the indicator; an acquisition section that acquires the first attribute which is stored in the first storage section; and a second control section that causes the second projection section to project an image of the line which is a line according to the locus of the indicator in the second area and which is drawn using the first attribute or the second attribute. Further, in a case in which a locus that is temporally or spatially continued and is extended from the first area to the second area is drawn by the indicator, the second control section causes the second projection section to project the image of the line which is a line according to the locus of the indicator in the second area and which is drawn using the first attribute acquired by the acquisition section. In the configuration, in a case in which a line, which is temporally or spatially continued and is extended from the first area onto which the first projector projects an image to the second area onto which the second projector projects an image, is drawn, the line is drawn using the first attribute, which is stored in the first projector, instead of the second attribute which is stored in the second projector. Therefore, the attribute of the line is changed on the way, and thus it is possible to reduce a possibility that a line which is contrary to the intention of a user is drawn.

In a case in which the locus that is temporally or spatially continued and is extended from the first area to the second area is drawn by the indicator, the second control section may cause the second projection section to project an image object for causing a user to select an attribute of the line in the image which is projected by the second projection section, and the second control section may cause the second projection section to project the image of the line which is drawn using the attribute selected through the image object. Therefore, in a case in which the attribute of the drawn line is contrary to the intention of the user, it is easy to change the attribute of the line.

The image object may include alternatives for selecting the attribute which is stored in the second storage section. Therefore, in a case in which the attribute of the drawn line is contrary to the intention of the user, it is easy to change the attribute of the line.

In a case in which the locus which is temporally or spatially continued and which is extended from the first area to the second area is drawn by one indicator, the second control section may cause the second projection section to project the line, which is a line according to the locus of the indicator in the second area and which is drawn using the second attribute, and an image, which includes the image object for changing the attribute of the line into the first attribute, and, in a case in which an instruction to change the attribute of the line into the first attribute is input in the image object, the second control section may cause the second projection section to project the image of the line which has the attribute changed into the first attribute. Therefore, in a case in which the attribute of the drawn line is contrary to the intention of the user, it is easy to change the attribute of the line.

In a case in which a predetermined time elapses after the image object is displayed, the second control section may cause the second projection section to project an image from which the image object is removed. Therefore, it is possible to omit an operation of removing the displayed image object.

In a case in which, after the image of the line which is drawn using the attribute acquired by the acquisition section is projected by the second projection section, another locus which is not continued to the locus is drawn by the indicator in the second area, the second control section may cause the second projection section to project the image of the line which is a line according to the locus of the indicator in the second area and which is drawn using the second attribute. Therefore, it is possible to reduce a possibility that the line which is contrary to the intention of the user is drawn.

An image display method according to another aspect of the invention is an image display method in an image display system which includes a first projector and a second projector, the image display method including: projecting an image onto a first area by the first projector; storing a first attribute, which is an attribute of a line in a case in which the line is drawn according to a locus of an indicator, in a first storage section by the first projector; projecting an image of the line, which is a line according to the locus of the indicator in the first area and which is drawn using the first attribute, by the first projector; projecting an image onto a second area which has at least a part different from the first area by the second projector; storing a second attribute, which is an attribute of a line in a case in which the line is drawn according to the locus of the indicator, in a second storage section by the second projector; projecting an image of the line, which is a line according to the locus of the indicator in the second area and which is drawn using the attribute that is stored in the second storage section, by the second projector; acquiring the first attribute, which is stored in the first storage section, by the second projector; and projecting the image of the line, which is a line according to the locus of the indicator in the second area and which is drawn using the acquired first attribute, in a case in which the locus that is temporally or spatially continued and is extended from the first area to the second area is drawn by the indicator. In the configuration, in a case in which a line, which is temporally or spatially continued and is extended from the first area onto which the first projector projects an image to the second area onto which the second projector projects an image, is drawn, the line is drawn using the first attribute, which is stored in the first projector, instead of the second attribute which is stored in the second projector. Therefore, the attribute of the line is changed on the way, and thus it is possible to reduce a possibility that a line which is contrary to the intention of a user is drawn.

### BRIEF DESCRIPTION OF THE DRAWINGS

The invention will be described with reference to the accompanying drawings, wherein like numbers reference like elements.

FIG. 1 is a diagram illustrating the outline of a display system according to an embodiment.

FIG. 2 is a diagram illustrating a problem of the display system according to the related art.

FIG. 3 is a diagram illustrating the functional configuration of the display system.

FIG. 4 is a diagram illustrating the hardware configuration of a first projector.

FIG. 5 is a flowchart illustrating an example of the operation of the first projector.

FIG. 6 is a diagram illustrating a line which is drawn according to the locus of an indicator.

FIG. 7 is a flowchart illustrating an operation of a second projector according to a first example.

FIG. 8 is a flowchart illustrating the operation of the second projector according to the first example.

FIG. 9 is a diagram illustrating a line which is drawn according to the locus of an indicator in the first example.

FIG. 10 is a diagram illustrating a screen on which a pop-up menu is displayed.

FIG. 11 is a flowchart illustrating an operation of the second projector according to a second example.

FIG. 12 is a flowchart illustrating an operation of the second projector according to the second example.

FIG. 13 is a diagram illustrating a screen on which projection is performed in step S312.

FIG. 14 is a diagram illustrating the configuration of a display system according to a first modified example.

### DESCRIPTION OF EXEMPLARY EMBODIMENTS

### 1. Outline

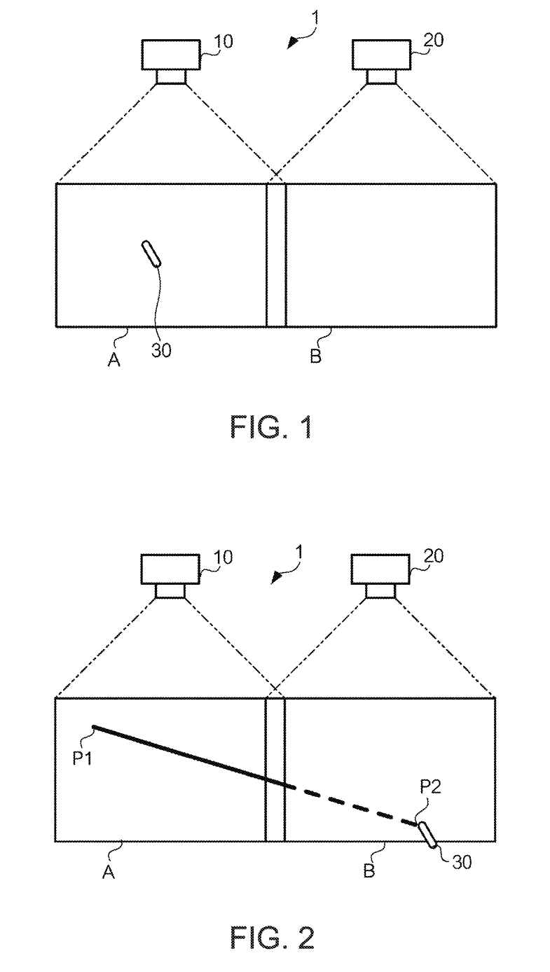

FIG. 1 is a diagram illustrating the outline of a display system 1 according to an embodiment. The display system 1 includes two projectors (a first projector 10 and a second projector 20). The first projector 10 projects an image onto an area A of a projection surface, and the second projector 20 projects an image on an area B, respectively. In the example, the area A is adjacent to the area B. Meanwhile, at least parts of the area A and the area B may be different, may be overlapped, and may be arranged at intervals.

In the example, both the first projector 10 and the second projector 20 are so-called interactive projectors. That is, the first projector 10 and the second projector 20 have functions of detecting a location of an indicator 30 on the projection surface and drawing a line according to the locus of the detected location (hereinafter, simply referred to as “the locus of the indicator”).

FIG. 2 is a diagram illustrating a problem of a display system according to the related art. Here, an example, in which one line is drawn from a point P1 in the area A to a point P2 of the area B using the indicator 30, is considered. An attribute of a line, which is drawn according to the locus of the indicator, for example, color, thickness, or a line type (solid line, broken line, dot-dashed line, or the like) is set for each projector. For example, in a case in which setting is made such that a line type is a solid line in the first projector 10 and a line type is a broken line in the second projector 20, the line is drawn by the solid line in the area A and the line is drawn by the broken line in the area B even though a user tries to draw one line which is continued from the area A to the area B.

In a case in which a line having an attribute that is contrary to the intention of the user is drawn, it is necessary for the user to change the attribute thereof after the line is drawn. For this, it is necessary for the user to perform procedures of first selecting a line, which is a target, for example, through an UI in order to change the attribute, subsequently selecting an item which is desired to be changed (for example, selecting a line type from among alternatives of color, thickness, and the line type), and further selecting an attribute value (for example, selecting a solid line from among alternatives of the solid line, a broken line, and a dot-dashed line). The operation is complicate for the user. In contrast, in the embodiment, in a case in which a line, which is continued over the display areas of the two projectors, is drawn, a technology of enabling the arrangement of the attribute of the line which is drawing by the two projectors is provided.

### 2. Configuration

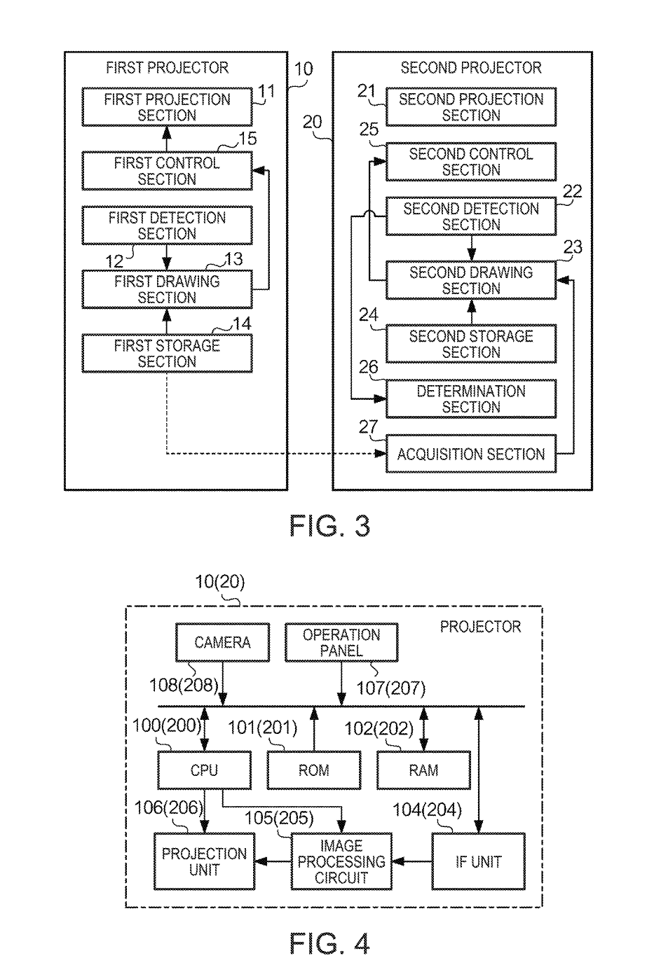

FIG. 3 is a diagram illustrating the functional configuration of the display system 1. The first projector 10 includes a first projection section 11, a first detection section 12, a first drawing section 13, a first storage section 14, and a first control section 15. The first projection section 11 projects an image on a first area (the area A of FIG. 1). The first detection section 12 detects a location of an indicator in the first area. The first drawing section 13 draws a line according to the locus of the location which is detected by the first detection section 12. The first storage section 14 stores the attribute of the line (an example of a first attribute) in a case in which the first drawing section 13 draws a line. The first control section 15 projects an image of the line which is drawn by the first drawing section 13 onto the first projection section 11.

The second projector 20 includes a second projection section 21, a second detection section 22, a second drawing section 23, a second storage section 24, a second control section 25, a determination section 26, and an acquisition section 27. The second projection section 21 projects an image on a second area (the area B of FIG. 1). The second detection section 22 detects a location of an indicator in the second area. The second drawing section 23 draws a line according to the locus of the location which is detected by the second detection section 22. The second storage section 24 stores the attribute of the line (an example of a second attribute) in a case in which the second drawing section 23 draws a line. The second control section 25 projects an image of the line which is drawn by the second drawing section 23 onto the second projection section 21. In a case in which the locus of the indicator is detected in the second area, the determination section 26 determines whether or not the locus is temporally or spatially connected to the image which is projected onto the first area. The acquisition section 27 acquires the attribute which is stored in the first storage section 14. In a case in which it is determined that the locus, which is detected in the second area, is connected to a line pertaining to the image which is projected onto the first area, the second drawing section 23 draws the line according to the locus of the indicator in the second area using the attribute which is acquired by the acquisition section 27, that is, attribute which is in common with the line projected on the first area. The second control section 25 projects an image of the line onto the second projection section 21.

FIG. 4 is a diagram illustrating the hardware configuration of the first projector 10 and the second projector 20. The first projector 10 includes a Central Processing Unit (CPU) 100, a Read Only Memory (ROM) 101, a Random Access Memory (RAM) 102, an IF unit 104, an image processing circuit 105, a projection unit 106, an operation panel 107, and a camera 108.

The CPU 100 is a control device which controls the respective sections of the first projector 10. The ROM 101 is a non-volatile storage device which stores various programs and data. The RAM 102 is a storage device which stores data, and functions as a work area in a case in which the CPU 100 performs a process.

The IF unit 104 is an interface which relays the exchange of signals or data with external devices. The IF unit 104 includes a terminal (for example, a VGA terminal, a USB terminal, a wired LAN interface, an S terminal, an RCA terminal, a High-Definition Multimedia Interface (HDMI: registered trademark) terminal, microphone terminal, or the like), which exchanges signals or data with an external device, and a wireless LAN interface. The terminal may include a video output terminal in addition to a video input terminal. The IF unit 104 may receive input of a video signal from a plurality of different video supply devices.

The image processing circuit 105 performs an image process (for example, size change, trapezoid correction, or the like) on the input video signal (hereinafter, referred to as an “input video signal”).

The projection unit 106 projects an image on the projection surface, such as a screen or a wall surface, according to the video signal which is given the image process. The projection unit 106 includes a light source, an optical modulator, and an optical system (all of them are not shown in the drawing). The light source includes a lamp, such as a high pressure mercury lamp, a halogen lamp, or a metal halide lamp, a solid light source, such as a Light Emitting Diode (LED) or a laser diode, and a driving circuit for the lamps. The optical modulator is a device which modulates light, which is irradiated from the light source, according to the video signal, and includes, for example, a liquid panel or a Digital Mirror Device (DMD), and a driving circuit for the devices. Meanwhile, the liquid panel may include either a transmission type or a reflection type. The optical system includes an element which projects light that is modulated by the optical modulator onto the screen, and includes, for example, a mirror, a lens, and a prism. The light source and the optical modulator may be provided for each color component.

The operation panel 107 is an input device for inputting an instruction to the projector 10 by the user, and includes, for example, a keyboard, a button, or a touch panel.

The camera 108 is a camera for specifying the location of the indicator 30. In the example, the indicator 30 includes a luminous body (for example, an infrared light emitting diode), a pressure sensor, and a control circuit (none of them are shown in the drawing) at a pen nib. If it is detected that the pen nib comes into contact with an object (projection surface or the like) by the pressure sensor, the control circuit causes the luminous body to emit light by a predetermined light emitting pattern. The camera 108 is an infrared camera, and photographs the image on the projection surface. The CPU 100 specifies the location of the indicator 30 and a relevant event from an image which is photographed by the camera 108.

An event which is relative to the indicator 30 includes, for example, a pen-down event and a pen-up event. The pen-down event is an event which indicates that the indicator 30 comes into contact with a display surface (in the example, the screen or the wall surface). The pen-down event includes coordinates which indicate the location with which the indicator 30 comes into contact. The pen-up event is an event which indicates that the indicator 30, which comes into contact with the display surface until that time, is separated from the display surface. The pen-up event is includes coordinates which indicate a location in which the indicator 30 is separated from the display surface.

Meanwhile, the camera 108 is capable of photographing a range (that is, the outside of the screen) which is wider than a valid pixel area of the image which is projected by the projection unit 106. That is, the projector 10 can detect the location of the indicator 30 even in a case in which the indicator 30 is present on the outside of the screen (if the indicator 30 is present within a predetermined range).

In the example, the second projector 20 has a hardware configuration which is in common with the first projector 10. The reference symbols of the hardware components of the second projector 20 are described in parentheses in FIG. 4.

In the first projector 10, the projection unit 106 is an example of the first projection section 11. The camera 108 is an example of the first detection section 12. The CPU 100 is an example of the first drawing section 13 and the first control section 15. The RAM 102 is an example of the first storage section 14.

In the second projector 20, a projection unit 206 is an example of the second projection section 21. A camera 208 is an example of the second detection section 22. A CPU 200 is an example of the second drawing section 23, the second control section 25, and the determination section 26. A RAM 202 is an example of the second storage section 24. An IF unit 204 is an example of the acquisition section 27.

The first projector 10 and the second projector 20 are connected to each other to be capable of exchanging data through the IF unit 104 and the IF unit 204. In the example, the first projector 10 and the second projector 20 are directly connected through wired or wireless manner. Meanwhile, the first projector 10 and the second projector 20 may be connected through a LAN or Internet.

### 3. Operation

Hereinafter, some examples of the operation of the display system 1 will be described. In examples below, an attribute value, which is used in a case of drawing a line, is stored in the first projector 10 and the second projector 20. The attribute value is changed according to an instruction of the user. That is, if the instruction of the user is input, the stored attribute value is rewritten. In the examples below, as the attributes of the line, three attributes, that is, color, thickness, and line type are used.

### 3-1. Drawing of Line

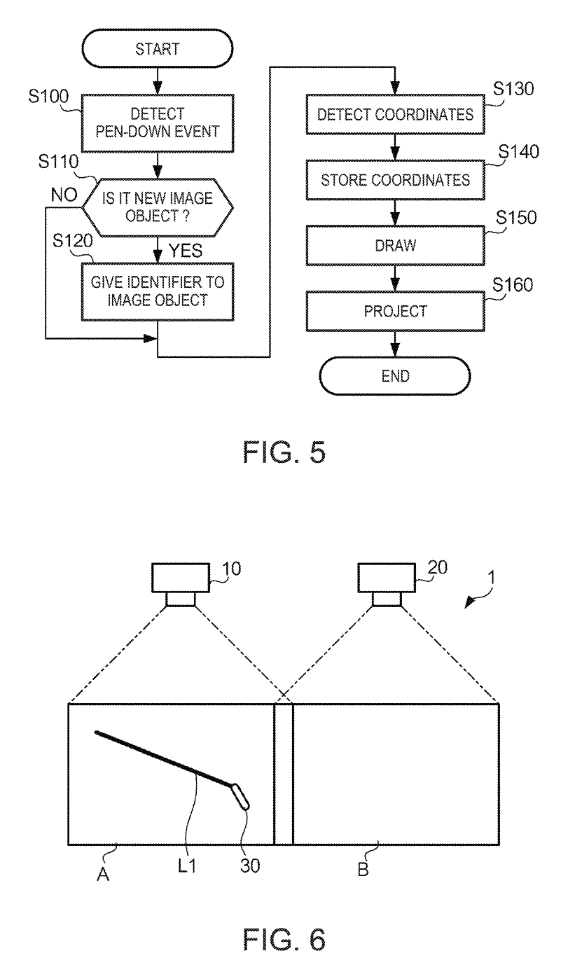

FIG. 5 is a flowchart illustrating an example of the operation of the first projector 10. Here, first, the drawing of a line in one projector will be described.

In step S100, the CPU 100 detects that a pen-down event occurred. The CPU 100 performs sampling on the image which is photographed by the camera 108 on a predetermined cycle, and detects the pen-down event from the image.

In step S110, the CPU 100 determines whether or not the detected pen-down event forms a new image object. It is determined that a pen-down event, which is spatially or temporally continued, forms a series of image objects. Specifically, in a case in which the pen-down event is continuously detected from a previous time (in an immediately before sampling), it is determined that the pen-down event is continued to a previous pen-down event. In a case in which, although the pen-down event is not detected in previous sampling, the elapsed time from when the pen-up event is detected is equal to or less than a threshold in sampling two times before and a distance between the location of the indicator 30 at that time and the location of the currently detected indicator 30 is equal to or less than a threshold, it is determined that the pen-down event is continued to the previously detected pen-down event.

In a case in which it is determined that the detected pen-down event forms the new image object (S110: YES), the CPU 100 shifts the process to step S120. In a case in which it is determined that the detected pen-down event is continued to the previously detected pen-down event (S110: NO), the CPU 100 shifts the process to step S130.

In step S120, the CPU 100 gives an identifier to the new image object (a series of pen-down events).

In step S130, the CPU 100 detects coordinates of the indicator 30 in a case in which the pen-down event occurred. The CPU 100 detects the coordinates of the indicator 30 from the image on which the sampling is performed.

In step S140, the CPU 100 stores the coordinates of the indicator 30. The CPU 100 stores the coordinates of the indicator 30 and data indicative of time, in which the coordinates are detected, in the RAM 102 together with the identifier of the image object which includes the coordinates. Hereinafter, the coordinates of the indicator 30 and the data indicative of the time are referred to as “drawing information”.

In step S150, the CPU 100 draws a line (image object) indicative of the locus of the indicator 30. Here, “draw a line” indicates to generate data for displaying the image of the line. The CPU 100 draws a line according to a series of coordinates which are stored in the RAM 102. The CPU 100 draws, for example, a line which passes through each of the coordinates. The CPU 100 draws a series of pen-down events as one continued line. In the RAM 102, data, which designates the attribute of a line to be drawn, is stored. The CPU 100 draws a line having the attribute according to the data.

In step S160, the CPU 100 controls the projection unit 106 such that the image which indicates the drawn line is projected. Processes in steps S100 to S160 are repeatedly performed on a predetermined cycle. Meanwhile, a cycle in which the coordinates of the indicator 30 are detected, a cycle in which a line is drawn, and a cycle in which an image to be projected is updated may be not the same and may be different from each other.

FIG. 6 is a diagram illustrating the line which is drawn according to the locus of the indicator 30. A series of loci are drawn as one line L1 and is treated as a single object on data.

3-2. Drawing of Line over Area A and Area B

Subsequently, drawing of a line, which is continued from a starting point in the area A to an end point in the area B, will be described. The drawing of the line in the area A, that is, the operation of the first projector 10 is the same as the description with reference to FIG. 5. Hereinafter, the operation of the second projector 20 will be mainly described. Since the operation of the second projector 20 includes some ways, the ways will be sequentially described.

### 3-2-1. First Example

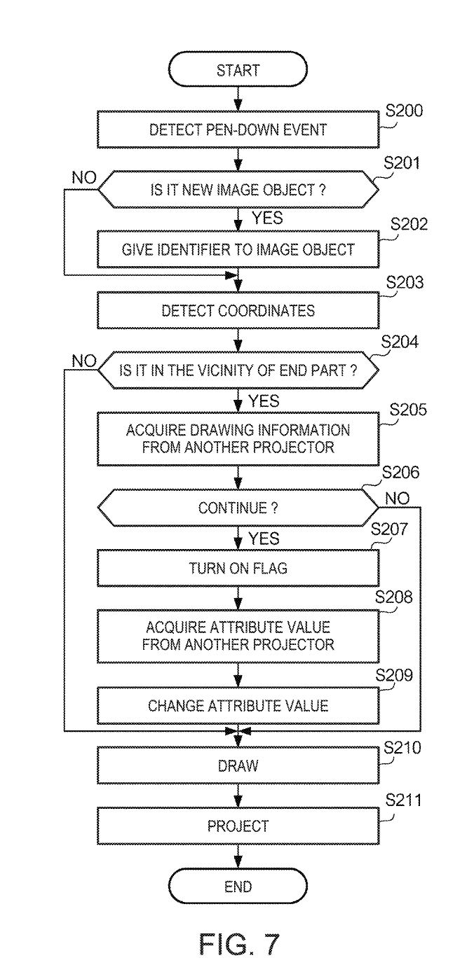

FIG. 7 is a flowchart illustrating an operation of the second projector 20 according to a first example. Here, specifically, an operation, performed in a case in which the pen-down event is detected, is illustrated.

In step S200, the CPU 200 detects that a pen-down event occurred. The CPU 200 performs sampling on an image, which is photographed by the camera 208, on a predetermined cycle, and detects the pen-down event from the image.

In step S201, the CPU 200 determines whether or not the detected pen-down event forms a new image object. In a case in which it is determined that the detected pen-down event forms the new image object (S201: YES), the CPU 200 shifts the process to step S202. In a case in which it is determined that the detected pen-down event is continued to a previously detected pen-down (S201: NO), the CPU 100 shifts the process to step S203.

In step S202, the CPU 200 gives an identifier to the new image object (a series of pen-down events).

In step S203, the CPU 200 detects the coordinates of the indicator 30 acquired in a case in which the pen-down event occurred. The CPU 200 detects the coordinates of the indicator 30 from the image on which the sampling is performed.

In step S204, the CPU 200 determines whether or not a location where the pen-down event is detected is in the vicinity of the end part of the area B. Here, the vicinity of the end part refers to, for example, a range in a predetermined distance from a side of a direction in which another projector is present from among the end parts (up, down, the left, and the right ends) of the area B. In the example, since the first projector 10 is present in a left side direction toward the projection surface, the vicinity of the end part refers to a range in a predetermined distance from the left side of the area B. Information indicative of the locational relationship with another projector is stored in, for example, a ROM 201. In a case in which it is determined that the location where the pen-down event is detected is the vicinity of the end part of the area B (S204: YES), the CPU 200 shifts the process to step S205. In a case in which it is determined that the location where the pen-down event is detected is not the vicinity of the end part of the area B (S204: NO), the CPU 200 shifts the process to step S210.

In step S205, the CPU 200 acquires the drawing information from the first projector 10. Specifically, the CPU 200 requests to transmit the drawing information from the first projector 10. The first projector 10 transmits the drawing information to the second projector 20 at the request. Here, the drawing information to be transmitted is, for example, drawing information relevant to one point which is detected at the latest.

In step S206, the CPU 200 determines whether or not an image object, which is lastly drawn in the first projector 10, is continued to a new image object in the second projector 20 using the drawing information which is acquired from the first projector 10. Specifically, the CPU 200 compares the drawing information which is acquired from the first projector 10 (hereinafter, referred to as “first drawing information”) with the drawing information (hereinafter, referred to as “second drawing information”) which is detected in step S203, and determines whether or not both the pieces of information satisfy predetermined conditions. The predetermined conditions include, for example, the difference between the coordinates of the indicator 30 pertaining to the first drawing information and the coordinates of the indicator 30 pertaining to the second drawing information is less than the threshold, and the difference between times in which the coordinates are detected is less than the threshold. Here, the threshold of the difference in the coordinates and the threshold of the difference in the times are values, which correspond to sufficiently small distance and time, to the extent of assuming that the image object is continued.

In a case in which it is determined that the image object, which is lastly drawn in the first projector 10, and the new image object in the second projector 20 are continued (S206: YES), the CPU 200 shifts the process to step S207. In a case in which it is determined that both the image objects are not continued (S206: NO), the CPU 200 shifts the process to step S210.

In step S207, the CPU 200 turns on a flag. If the flag is turned on, the flag indicates that the image object to be drawn at that point of time is continued to an image object which is drawn by the first projector 10, and, if the flag is turned off, the flag indicates that the image objects are not continued. More specifically, the RAM 202 has a storage area which stores data of the flag, and the turning on and off of the flag is switched in such a way that the CPU 200 rewrites the data of the storage area.

In step S208, the CPU 200 acquires an attribute value relevant to the drawing of the image object from the first projector 10. Specifically, the CPU 200 requests to transmit the attribute value relevant to the drawing of the image object from the first projector 10. The first projector 10 transmits the attribute value to the second projector 20 at the request. Here, the attribute value which is transmitted is the attribute value (for example, the color, the thickness, and the line type of a line) of the image object which is drawn at the latest.

In step S209, the CPU 200 changes the attribute value, which is acquired in a case in which the image object is drawn, into the attribute value which is acquired from the first projector 10. Meanwhile, the CPU 200 backs the attribute value, which is acquired before the change, up and stores the attribute value in the RAM 202.

In step S210, the CPU 200 draws a line (image object) indicative of the locus of the indicator 30. The CPU 200 draws a line according to a series of coordinates which are stored in the RAM 202. The CPU 200 draws, for example, a line which passes through each of the coordinates. The CPU 200 draws a series of pen-down event as one continued line. In the RAM 202, data (attribute value data) which designates the attribute of the line to be drawn is stored. The CPU 200 draws a line having the attribute according to the data.

In a case in which the image object of the second projector 20 is continued to the image object of the first projector 10, the attribute of the image object which is drawn in step S209 is the same as that of the image object of the first projector 10. In a case in which the image object of the second projector 20 is not continued to the image object of the first projector 10, the attribute of the image object which is drawn in step S209 is the attribute which is set in the second projector 20, and is not limited to the same image object of the first projector 10.

In step S211, the CPU 200 controls the projection unit 206 such that an image which indicates the drawn line is projected. The processes insteps S200 to S211 are repeatedly performed on a predetermined cycle. Meanwhile, a cycle in which the coordinates of the indicator 30 are detected, a cycle in which a line is drawn, and a cycle in which an image to be projected is updated may be not the same and may be different from each other.

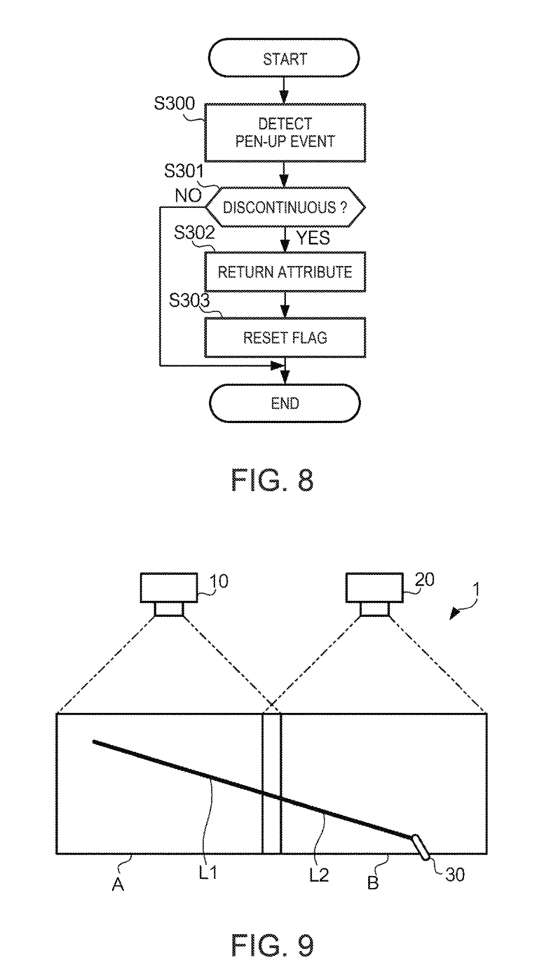

FIG. 8 is a flowchart illustrating the operation of the second projector 20 according to the first example. Here, particularly, an operation, which is performed in a case in which the pen-up event is detected, is described.

In step S300, the CPU 200 detects that a pen-up event occurred. The CPU 200 detects the pen-up event from the image which is photographed by the camera 208.

In step S301, the CPU 200 determines whether or not a condition in which the image objects are not continued is satisfied. The condition in which the image objects are not continued is a condition which is determined that an image object, which is drawn until immediately before the pen-up event is detected, and an image object, which is drawn after the image object, are separate (discontinuous) image objects. The condition includes, for example, a condition that time, which elapses while a subsequent pen-down event is not detected after the pen-up event is detected, exceeds the threshold. In a case in which the condition in which the image objects are not continued is satisfied (S301: YES), the CPU 200 shifts the process to step S302. Ina case in which the condition in which the image objects are not continued is not satisfied (S302: NO), the CPU 200 waits (if a subsequent pen-down event is detected during the period, the process is performed according to the flow of FIG. 7).

In step S302, the CPU 200 returns the attribute value acquired in a case in which the image object is drawn, to a value acquired before the change is performed in step S209 (FIG. 7), that is, a value which is originally set in the second projector 20. In step S303, the CPU 200 resets, that is, turns off the flag.

According to the flow, if the drawing of the series of image objects, which are continued from the first projector 10, ends, the attribute value acquired when the image object is drawn is returned to a value which is originally set in the second projector 20. That is, after this, if the user moves the indicator 30 to the area B, the line which is drawn using the attribute stored in the RAM 202 is projected.

FIG. 9 is a diagram illustrating a line which is drawn according to the locus of the indicator 30 in the first example. According to the locus of the indicator 30, a line L1 in the area A and a line L2 in the area B are drawn. The line L1 and the line L2 are drawn using the same attribute. In the example, both the lines are drawn using solid lines.

According to the example, an image object, which is continued to the image object which is drawn in the area A, is automatically drawn in the area B using the attribute which is in common with the area A.

Meanwhile, in the flow of FIG. 8, in a case in which the condition in which the image object is not continued is satisfied, the CPU 200 controls the projection unit 206 such that a pop-up menu (an example of an image object) is projected as an UI object for receiving an instruction to change the attribute value of the drawn image object into an attribute value (that is, the attribute value which is originally set in the second projector 20) which is back-up and stored in the RAM 202.

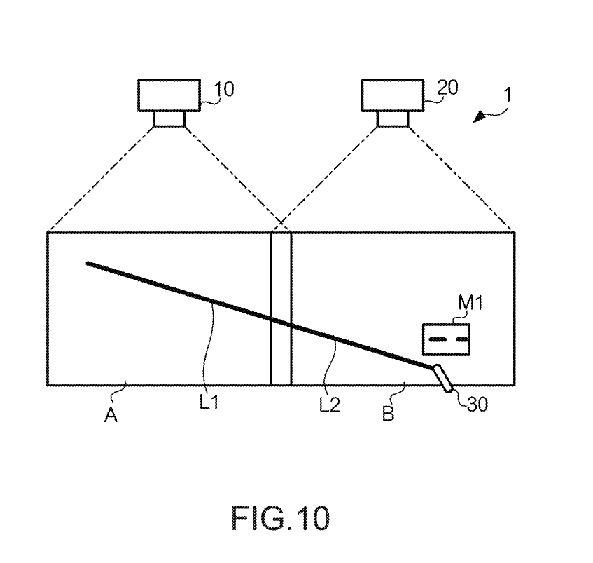

FIG. 10 is a diagram illustrating a screen on which a pop-up menu M1 for changing the attribute of the drawn image object is displayed. The pop-up menu M1 is displayed at the end point of the line L2, that is, in a location according to the location where the pen-up event is detected (vicinity of the end point of the line L2). The pop-up menu M1 includes an item for changing the attribute value into a value which is back-up and stored in the RAM 202 as an alternative. If the user touches the location where the item is projected using the indicator 30, the attribute of the line L2 is changed.

According to the example, in a case in which, for example, the line L1 and the line L2 are recognized as continued image objects even though the user intentionally draws the line L2 and the line L1 as separate image objects, it is possible to simply change the attribute of the line L2. Meanwhile, the CPU 200 may remove the pop-up menu M1 from the screen in a case in which predetermined time elapses after the pop-up menu M1 is displayed.

Meanwhile, in the example, description in which a function of the first projector 10 is different from a function of the second projector 20 is performed. However, actually, the function of the first projector 10 is common to the function of the second projector 20. Further, for example, in a case in which a line that is continued from the starting point in the area B to the end point in the area A is drawn, a process of replacing the first projector 10 and the second projector 20 with each other in the above description may be performed.

### 3-2-2. Second Example

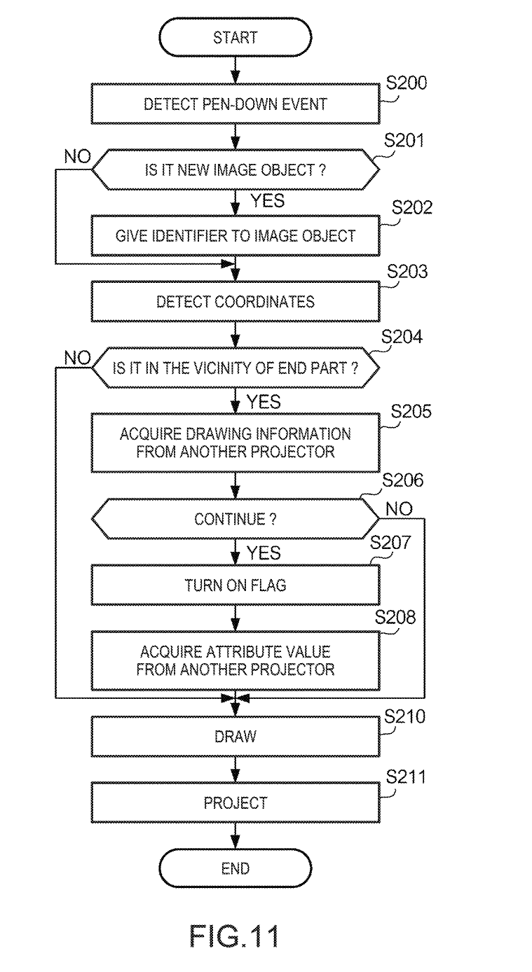

FIG. 11 is a flowchart illustrating an operation of the second projector 20 according to a second example. Here, particularly, an operation performed in a case in which the pen-down event is detected is illustrated. In FIG. 11, the same reference symbols are used to indicate the common processes in FIG. 7. In the second example, a fact that the process of changing the attribute value in step S209 is not performed is different from the first example. That is, in the second example, even in a case in which it is determined to be an image object that is continued to the image object which is drawn by the first projector 10, drawing is performed using the attribute value which is set in the second projector 20, instead of the attribute value of the first projector 10.

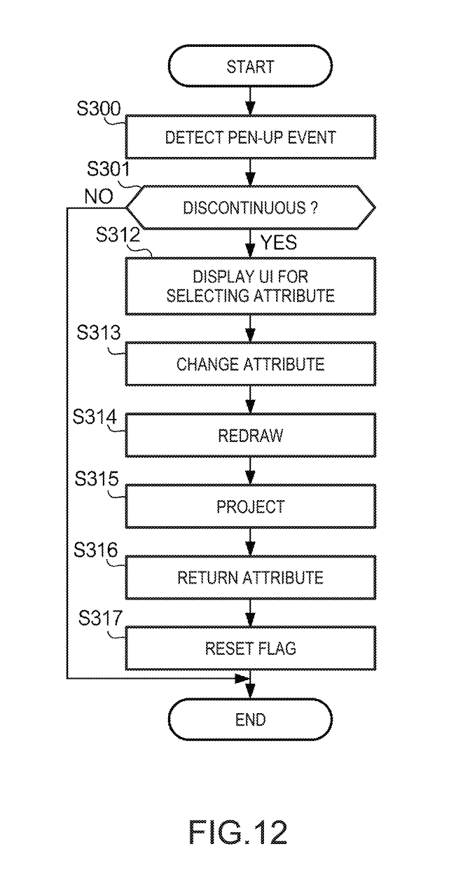

FIG. 12 is a flowchart illustrating an operation of the second projector 20 according to the second example. Here, particularly, an operation performed in a case in which the pen-down event is detected is illustrated. In FIG. 12, the same reference symbols are used to indicate the common processes in FIG. 8. The processes of steps S300 and S301 are common to the first example. However, in step S301 according to the second example, in a case in which the condition in which the image object is not continued is satisfied (S301: YES), the CPU 200 shifts the process to step S312.

In step S312, the CPU 300 controls the projection unit 206 such that an UI object for selecting the attribute of the drawn image object is projected.

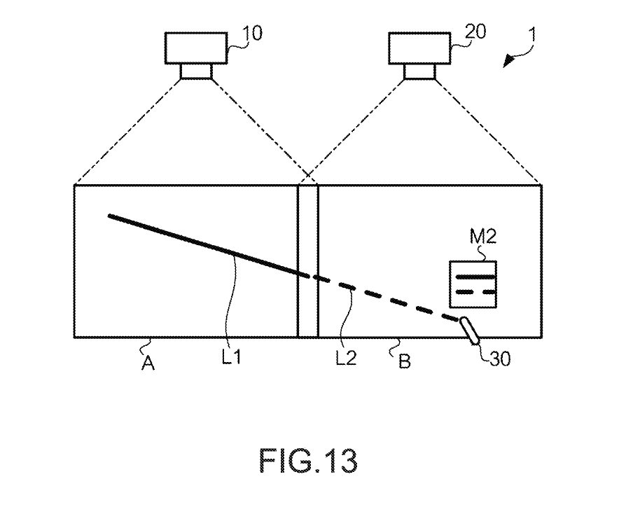

FIG. 13 is a diagram illustrating a screen on which projection is performed in step S312. Here, the line L1 is drawn by a solid line in the area A and the line L2 is drawn by a broken line in the area B. In the vicinity of a location where the pen-up event is detected (that is, the end point of the line L2), a pop-up menu M2 is displayed. The pop-up menu M2 is an example of a UI object for selecting the attribute of a drawn image object. The pop-up menu M2 includes an item to be changed into an attribute value (for example, the solid line) which is in common with the first projector 10 and an item which maintains the attribute value that is set in the second projector 20 as alternatives.

FIG. 12 will be referred to again. In step S313, the CPU 200 changes the attribute of the line L2 according to an operation performed on the pop-up menu M2 by the user. In a case in which, for example, the item to be changed into the attribute value which is in common with the first projector 10 is selected in the pop-up menu M2, the attribute of the line L2 is changed into an attribute which is common to the line L1. Otherwise, in a case in which the item which maintains the attribute value that is set in the second projector 20 is selected, the attribute of the line L2 is maintained without change.

In step S314, the CPU 200 redraws the drawn image object (in the example, the line L2). To redraw means to remove a line, which is drawn using an attribute acquired before change, and to newly generate a line which is drawn using an attribute acquired after the change. In step S315, the CPU 200 projects an image which includes the redrawn image object.

In step S316, the CPU 200 returns an attribute value, acquired in a case in which the image object is drawn, to a value acquired before change in step S313, that is, a value which is originally set in the second projector 20. Meanwhile, in a case in which the attribute is not changed in step S313, the process in step S313 is skipped. In step S317, the CPU 200 resets, that is, turns off the flag.

According to the example, in a case in which an image object, which is continued to the image object drawn in the area A, is drawn, an UI object for selecting an attribute in the area B is automatically displayed. Meanwhile, the CPU 200 may remove the pop-up menu M2 from the screen in a case in which predetermined time elapsed after the pop-up menu M2 is displayed.

### 4. Modified Example

The invention is not limited to the above-described embodiments, and various modified examples are possible. Hereinafter, some modified example will be described. Two or more modified examples below may be combined and used.

### 4-1. First Modified Example

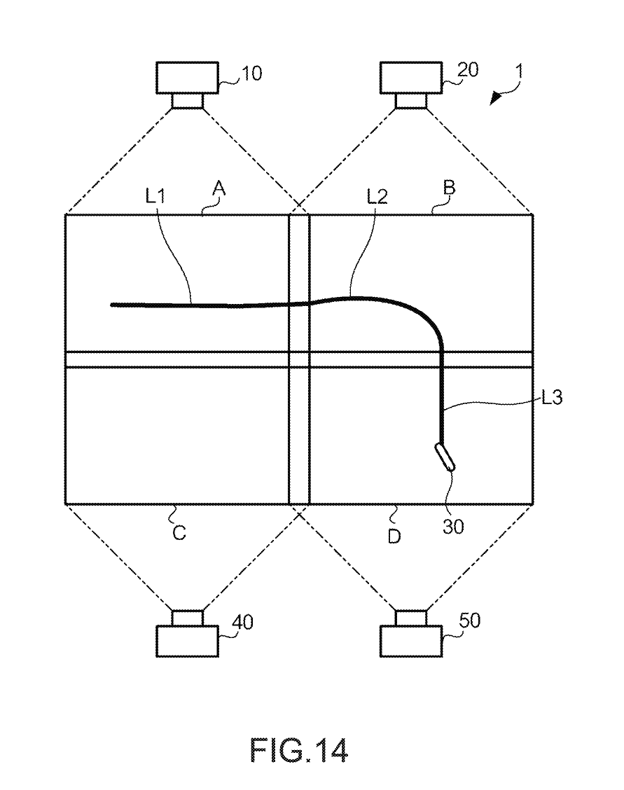

FIG. 14 is a diagram illustrating the configuration of a display system 1 according to a first modified example. The number of projectors which are included in the display system 1 is not limited to two. The display system 1 may include three or more projectors. FIG. 14 illustrates an example in which the display system 1 includes four projectors, that is, a third projector 40 that projects an image onto an area C and a fourth projector 50 that projects an image onto an area D, in addition to the first projector 10 and the second projector 20.

In the example of FIG. 14, a continued line which passes through the area B from the starting point in the area A and reaches to the end point in the area C is drawn. The attribute of the line L2 in the area B uses a value which is the same as the attribute of the line L1 in the area A, and the attribute of the line L3 in the area C uses a value which is the same as the attribute of the line L2 (that is, the same as the line L1).

### 4-2. Second Modified Example

In the embodiment, an example, in which the functions of the projectors included in the display system 1 are equivalent, has been described. In the second modified example, one predetermined projector (base unit) of a plurality of projectors manages attributes in a case in which image objects are drawn of the other projectors (extension units). In a case in which an attribute value of another projector is necessary in the extension units, the extension units inquire of the base unit. In a case in which an attribute value of another projector is necessary in the base unit, the base unit refers to information which is stored in the base unit.

For example, in the display system 1 of FIG. 1, an example in which the first projector 10 is the base unit and the second projector 20 is an extension unit is considered. Each of the projectors stores information, which indicates whether the projector is the base unit or the extension unit, and the identifier of the base unit in a case in which the projector is the extension unit. At a predetermined timing, for example, whenever the attribute value is changed, the second projector 20 transmits an attribute value, which is valid at that time, to the first projector 10 which is the base unit. The first projector 10 associates the valid attribute value in the extension unit with the identifier of the extension unit, and stores the valid attribute value. In a case in which the attribute value of the first projector 10 is necessary in the second projector 20, the second projector 20 inquires the attribute value of the first projector 10. In a case in which there are inquiries, the first projector 10 transmits the attribute value, which is used to draw an image in the first projector 10, to the second projector 20. In a case in which the attribute value of another projector is necessary in the first projector 10, the first projector 10 refers to information which is stored in the first projector 10.

In an additional example, in the display system 1 of FIG. 14, an example, in which the first projector 10 is a base unit, and the second projector 20, the third projector 40, and the fourth projector 50 are extension units, is considered. The respective projectors are connected to each other through a network. For example, in a case in which the attribute value of the second projector 20 is necessary in the fourth projector 50, the fourth projector 50 inquires the attribute value of the first projector 10.

Meanwhile, a server device (not shown in the drawing) may manage the attribute values which are used to draw images in the respective projectors, instead of the projectors. In the example, all of the projectors transmit attribute values, which are valid at that time, to the server device at a predetermined timing, for example, whenever the attribute value is changed. The server device associates the valid attribute values in the respective projectors with the identifiers of the projectors, and stores the valid attribute values. In a case in which an attribute value of another projector is necessary in a certain projector, the projector inquires an attribute value which is valid for another projector of the server device.

### 4-3. Another Modified Example

The detailed flow of the process performed by the second projector 20 is not limited to the examples illustrated in FIGS. 7, 8, 11, and 12. For example, a timing in which an attribute value is acquired from another projector is not limited to the examples illustrated in the embodiments. Independent from the flows, an attribute value may be periodically acquired from another projector, for example, at a predetermined timing.

The hardware configuration which realizes the functions illustrated in FIG. 3 is not limited to the example illustrated with reference to FIG. 4. If it is possible to realize required functions, the respective projectors may have any hardware configurations. For example, each of the projectors may include a so-called stereo camera or a laser curtain as a hardware component corresponding to the detection section (the first detection section 12 and the second detection section 22). In addition, the configuration of the indicator 30 is not limited to the example described in the embodiment. The indicator 30 may be, for example, a structure which is coated with paint which reflects light in a specified wavelength range. Otherwise, the indicator 30 may be a finger of the user.

What is claimed is:

1. An image display system comprising:
a first projector; and
a second projector,
wherein the first projector includes
a first projection section that projects an image onto a first area;
a first storage section that stores a first attribute which is an attribute of the line in a case in which a line is drawn according to a locus of an indicator; and
a first control section that causes the first projection section to project an image of the line which is a line according to the locus of the indicator in the first area and which is drawn using the first attribute,
wherein the second projector includes
a second projection section that projects an image onto a second area which has at least a part different from the first area;
a second storage section that stores a second attribute which is an attribute of the line in a case in which a line is drawn according to the locus of the indicator;
an acquisition section that acquires the first attribute which is stored in the first storage section; and
a second control section that causes the second projection section to project an image of the line which is a line according to the locus of the indicator in the second area and which is drawn using the first attribute or the second attribute, and
wherein, in a case in which a locus that is temporally or spatially continued and is extended from the first area to the second area is drawn by the indicator, the second control section causes the second projection section to project the image of the line which is a line according to the locus of the indicator in the second area and which is drawn using the first attribute acquired by the acquisition section.

2. The image display system according to claim 1,
wherein, in a case in which the locus that is temporally or spatially continued and is extended from the first area to the second area is drawn by the indicator, the second control section causes the second projection section to project an image object for causing a user to select an attribute of the line in the image which is projected by the second projection section, and
wherein the second control section causes the second projection section to project the image of the line which is drawn using the attribute selected through the image object.

3. The image display system according to claim 2,
wherein the image object includes alternatives for selecting the attribute which is stored in the second storage section.

4. The image display system according to claim 1,
wherein, in a case in which the locus which is temporally or spatially continued and which is extended from the first area to the second area is drawn by one indicator, the second control section causes the second projection section to project the line, which is a line according to the locus of the indicator in the second area and which is drawn using the second attribute, and an image, which includes the image object for changing the attribute of the line into the first attribute, and
wherein, in a case in which an instruction to change the attribute of the line into the first attribute is input in the image object, the second control section causes the second projection section to project the image of the line which has the attribute changed into the first attribute.

5. The image display system according to claim 2,
wherein, in a case in which a predetermined time elapses after the image object is displayed, the second control section causes the second projection section to project an image from which the image object is removed.

6. The image display system according to claim 1,
wherein, in a case in which, after the image of the line which is drawn using the attribute acquired by the acquisition section is projected by the second projection section, another locus which is not continued to the locus is drawn by the indicator in the second area, the second control section causes the second projection section to project the image of the line which is a line according to the locus of the indicator in the second area and which is drawn using the second attribute.

7. An image display method in an image display system which includes a first projector and a second projector, the image display method comprising:
projecting an image onto a first area by the first projector;
storing a first attribute, which is an attribute of a line in a case in which the line is drawn according to a locus of an indicator, in a first storage section by the first projector;
projecting an image of the line, which is a line according to the locus of the indicator in the first area and which is drawn using the first attribute, by the first projector;
projecting an image onto a second area which has at least a part different from the first area by the second projector;
storing a second attribute, which is an attribute of a line in a case in which the line is drawn according to the locus of the indicator, in a second storage section by the second projector;
projecting an image of the line, which is a line according to the locus of the indicator in the second area and which is drawn using the attribute that is stored in the second storage section, by the second projector;
acquiring the first attribute, which is stored in the first storage section, by the second projector; and
projecting the image of the line, which is a line according to the locus of the indicator in the second area and which is drawn using the acquired first attribute, in a case in which the locus that is temporally or spatially continued and is extended from the first area to the second area is drawn by the indicator.
